(19) United States
(12) Patent Application Publication
(10) Pub. No.: US 2026/0269111 A1
(43) Pub. Date: Sep. 10, 2026

(54) Magnetic Bead And Method For Producing Magnetic Bead

(71) Applicant: SEIKO EPSON CORPORATION, Tokyo (JP)

(72) Inventors: Yasunari IKEDA, Shiojiri (JP); Michio NAKAMORI, Matsumoto (JP); Takeyoshi USHIKI, Shiojiri (JP)

(21) Appl. No.: 19/558,976

(22) Filed: Mar. 6, 2026

(30) Foreign Application Priority Data
Mar. 7, 2025 (JP) 2025-036180

(51) Int. Cl. H01F 1/153; H01F 1/03

(52) U.S. Cl. CPC H01F 1/15366; H01F 1/0315

(57) ABSTRACT

A magnetic bead contains: a first magnetic particle having magnetism; second magnetic particles having magnetism, the second magnetic particles being in contact with the first magnetic particle and having an average particle diameter smaller than an average particle diameter of the first magnetic particle; and a coating layer commonly covering the first magnetic particle and the second magnetic particles, the coating layer having a binding property to a target biological substance.

### CROSS-REFERENCE TO RELATED APPLICATION

The present application is based on, and claims priority from JP Application Serial Number 2025-036180, filed Mar. 7, 2025, the disclosure of which is hereby incorporated by reference herein in its entirety.

### BACKGROUND

### 1. Technical Field

The present disclosure relates to a magnetic bead and a method for producing a magnetic bead.

### 2. Related Art

Regarding magnetic beads used for extracting a target biological substance by magnetic separation, JP-A-2023-146932 discloses a technique of extracting a biological material using an aggregate of first beads having magnetism and second beads having magnetism and having an average particle diameter larger than that of the first beads. In the technique in JP-A-2023-146932, an amount of the biological material adsorbed to the magnetic beads can be increased while shortening a time required for the magnetic separation by using high magnetization of the first beads and a large specific surface area of the second beads.

JP-A-2023-146932 is an example of the related art.

As described in JP-A-2023-146932, in the magnetic separation, the target biological substance can be efficiently extracted by using a composite in which a plurality of magnetic particles having different average particle diameters are combined. However, in the technique in JP-A-2023-146932, there is a possibility that the aggregated magnetic particles are unintentionally separated from each other during the magnetic separation or the like.

### SUMMARY

According to a first aspect of the present disclosure, a magnetic bead is provided. The magnetic bead contains: a first magnetic particle having magnetism; second magnetic particles having magnetism, the second magnetic particles being in contact with the first magnetic particle and having an average particle diameter smaller than an average particle diameter of the first magnetic particle; and a coating layer commonly covering the first magnetic particle and the second magnetic particles, the coating layer having a binding property to a target biological substance.

According to a second aspect of the present disclosure, a method for producing a magnetic bead is provided. The production method includes: a contact step of applying a magnetic field to a first magnetic particle having magnetism and second magnetic particles having magnetism and having an average particle diameter smaller than an average particle diameter of the first magnetic particle to bring the first magnetic particle and the second magnetic particles into contact with each other; and a coating step of forming a coating layer having a binding property to a target biological substance so as to commonly cover the first magnetic particle and the second magnetic particles in contact with each other.

### BRIEF DESCRIPTION OF THE DRAWINGS

FIG. 1 is a diagram illustrating a schematic configuration of a magnetic bead according to an embodiment.

FIG. 2 is a step chart showing a method for producing a magnetic bead according to an embodiment.

FIG. 3 is a diagram illustrating magnetic particles used in an evaluation test.

FIG. 4 is a diagram illustrating evaluation results in the evaluation test.

### DESCRIPTION OF EMBODIMENTS

### A. Embodiment

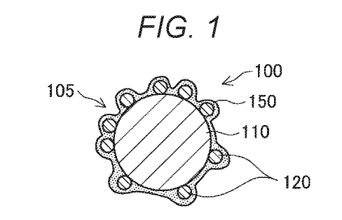

FIG. 1 is a diagram illustrating a schematic configuration of a magnetic bead 100 according to the embodiment. The magnetic bead 100 is for use in a magnetic separation method. The magnetic separation method is a method of extracting a target biological substance using an external magnetic field. The magnetic separation method using magnetic beads is also referred to as a "magnetic bead method". The "target biological substance " means a biological material to be extracted in the magnetic separation method.

In the magnetic separation method, first, the target biological substance is adsorbed to the magnetic bead 100 by charging the magnetic bead 100 into a dispersion liquid in which the target biological substance and impurities are dispersed. At this time, a lysis and adsorption liquid is usually used for the purpose of taking out the target biological substance encapsulated in a cell membrane or nucleus from the cell membrane or nucleus. As the lysis and adsorption liquid, for example, a liquid containing a chaotropic material, particularly a liquid containing guanidine thiocyanate or guanidine hydrochloride having a strong protein-modifying action is preferably used. Next, a solid phase containing the magnetic bead 100 and the target biological substance is separated from the liquid phase of the dispersion liquid by using an external magnetic field. Then, the separated solid phase, that is, the target biological substance adsorbed on the magnetic bead 100, is eluted from the magnetic bead 100 into a predetermined eluate. As a result, the target biological substance is extracted. The impurities are, for example, a biological material other than the target biological substance. In the present disclosure, in the magnetic separation method, the step of separating the solid phase and the liquid phase using the external magnetic field is particularly also referred to as "solid-liquid separation".

The biological material refers to, for example, materials such as nucleic acids such as DNA or RNA, proteins, saccharides, various cells such as cancer cells, peptides, bacteria, and viruses. Note that, the nucleic acid may be present, for example, in a state of being contained in a biological sample such as a cell or a biological tissue, a virus, a bacterium, or the like.

FIG. 1 schematically shows the schematic configuration of the magnetic bead 100. The magnetic bead 100 includes a first magnetic particle 110, second magnetic particles 120, and a coating layer 150. In FIG. 1, the first magnetic particle 110 is hatched upward to the right. The second magnetic particles 120 are hatched downward to the right. The coating layer 150 is hatched with dots.

The first magnetic particle 110 corresponds to a core of the magnetic bead 100. The second magnetic particles 120 have an average particle diameter smaller than an average particle diameter of the first magnetic particles 110. The coating layer 150 commonly covers the first magnetic particle 110 and the second magnetic particles 120. That is, the magnetic bead 100 includes a particle aggregate 105 in which the first magnetic particle 110 and the second magnetic particles 120 are aggregated, and the coating layer 150 that covers the particle aggregate 105. Note that, the coating layer 150 may cover at least a part of a surface of the particle aggregate 105. However, the coating layer 150 preferably covers the entire surface of the particle aggregate 105.

The magnetic bead 100 uses a binding property of the coating layer 150 to be described later, and the magnetic bead 100 uses the binding property of the coating layer 150 to adsorb the target biological substance to a surface of the coating layer 150, thereby capturing the target biological substance. In addition, the magnetic bead 100 is subjected to solid-liquid separation using the magnetism of the particle aggregate 105. In the embodiment, the target biological substance is a nucleic acid. More specifically, the target biological substance is DNA.

The first magnetic particles 110 are particles having magnetism. The first magnetic particles 110 preferably contain at least one of iron (Fe), cobalt (Co), and nickel (Ni) as an element. In particular, from the viewpoint of obtaining high saturation magnetization, it is preferable that the first magnetic particles 110 contain Fe. In addition, the first magnetic particles 110 preferably contain Fe as a main component. In the present disclosure, the "main component" refers to a component contained in a certain material at an atomic ratio of 50% or more. The atomic ratio of Fe in the first magnetic particles 110 is more preferably 70% or more. Note that, the "saturation magnetization" is a value of magnetization indicated by a magnetic material when a sufficiently large magnetic field is applied from the outside.

In addition, the first magnetic particles 110 are preferably made of a metal containing Fe as a main component. The first magnetic particles 110 may be a Fe-based alloy, and may be, for example, a Fe-Co-based alloy, a Fe-Ni-based alloy, a Fe-Co-Ni-based alloy, or a compound containing Fe, Co, and Ni. The Fe-based alloy means an alloy containing Fe as a main component. Further, from the viewpoint of obtaining high saturation magnetization, as the first magnetic particles 110, a carbonyl iron powder made of substantially 100 mass% of Fe, a Fe-Si-based alloy powder, a Fe-Si-Cr-based alloy powder, or the like is preferably used.

The Fe-based alloy can contain, in addition to an element that exhibits ferromagnetism by itself such as Co and Ni, one or two or more selected from the group including chromium (Cr), niobium (Nb), copper (Cu), aluminum (Al), manganese (Mn), molybdenum (Mo), silicon (Si), tin (Sn), boron (B), carbon (C), phosphorus (P), titanium (Ti), and zirconium (Zr), according to target properties. Si is a main element in the alloy powder, and is also an element that promotes amorphization of the Fe-based alloy.

Note that, the Fe-based alloy may contain impurities as long as the effects of the first magnetic particles 110 are not impaired. The impurities in the embodiment are elements that are unintentionally mixed in raw materials of the first magnetic particles 110 or mixed during the production of the first magnetic particles 110. The impurities are not particularly limited, and examples thereof include oxygen (O), nitrogen (N), sulfur (S), sodium (Na), magnesium (Mg), and potassium (K).

An example of the Fe-based alloy is an alloy having a content of Si of preferably 1.0 atomic% or more and 30.0 atomic% or less, more preferably 1.5 atomic% or more and 13.0 atomic% or less, and still more preferably 2.0 atomic% or more and 7.0 atomic% or less. Since such an alloy has a high permeability, the saturation magnetization tends to be high.

In addition, the Fe-based alloy may contain at least one of boron (B) in a content of 5.0 atomic% or more and 16.0 atomic% or less and carbon (C) in a content of 0.5 atomic% or more and 5.0 atomic% or less. These elements promote the amorphization of the Fe-based alloy and contribute to formation of a stable amorphous structure in the first magnetic particles 110.

Further, the Fe-based alloy preferably contains Cr in a content of 1.0 atomic% or more and 8.0 atomic% or less. Accordingly, corrosion resistance of the first magnetic particles 110 can be enhanced. As a result, elution of Fe ions from the first magnetic particles 110 can be prevented during the use of the magnetic bead 100. Since such Fe ions may adversely influence a test of the target biological substance, it is preferable to prevent the elution.

Note that, the content of the impurities in the Fe-based alloy is preferably 1.0 atomic% or less in total of all elements. In this way, even when the Fe-based alloy contains impurities, it is possible to prevent the function of the first magnetic particles 110 from being impaired due to the impurities.

A particularly preferred example of the Fe-based alloy is an alloy containing Fe as a main component, having a content of Si of 2.0 mass% or more and 9.0 mass% or less, a content of B of 1.0 mass% or more and 5.0 mass% or less, and a content of Cr of 1.0 mass% or more and 3.0 mass% or less. Such a Fe-based alloy contains a stable amorphous structure, and thus has a low coercive force and has a high content of Fe, and thus has high saturation magnetization.

The elements and the composition of the first magnetic particles 110 can be specified by ICP emission spectrometry defined in JIS G 1258: 2014, spark emission spectrometry defined in JIS G 1253: 2002, or the like. Note that, the physical properties of the first magnetic particles 110 may be evaluated after the first magnetic particles 110 and the second magnetic particles 120 are separated from each other and the coating layer 150 by a chemical or physical method.

A main metal structure constituting the first magnetic particles 110 may take various forms such as a crystal structure, an amorphous structure, and a nanocrystal structure. The amorphous structure refers to a non-crystalline structure in which no crystal is present, and the nanocrystal structure refers to a structure mainly formed of fine crystals having a crystal grain diameter of 100 nm or less. In the first magnetic particles 110, each of the crystal structure, the amorphous structure, and the nanocrystal structure may be present alone, or may be present as a structure in which two or more thereof are mixed.

The first magnetic particles 110 particularly preferably have an amorphous structure. When the first magnetic particles 110 have an amorphous structure, hardness of the first magnetic particles 110 is improved. In addition, when the first magnetic particles 110 have an amorphous structure, the coercive force of the first magnetic particles 110 is further reduced, which contributes to improvement of dispersibility of the magnetic bead 100. Note that, a volume fraction of the amorphous structure in the first magnetic particles 110 is preferably 40% or more, and more preferably 60% or more. The volume fraction of the amorphous structure in the first magnetic particles 110 is obtained from a result of crystal structure analysis using X-ray diffraction. In the present disclosure, the structure having the highest volume fraction among the structures constituting the particle is also referred to as a main structure. The main structure of the first magnetic particles 110 is preferably an amorphous structure.

The metal structure of the first magnetic particles 110 can also be identified by crystal structure analysis using an X-ray diffraction method on the first magnetic particles 110. Alternatively, it can be specified by analyzing a structure observation image or a diffraction pattern of a sample cut out from the first magnetic particles 110 using a transmission electron microscope (TEM). More specifically, when the structure analyzed using the X-ray diffraction method is an amorphous structure, in peak analysis in the X-ray diffraction method, for example, a diffraction peak derived from a metal crystal such as an α-Fe phase is not observed. In addition, when the structure analyzed using the TEM is an amorphous structure, a so-called halo pattern is observed in an electron beam diffraction pattern in the TEM, and formation of a spot due to crystals is not observed. In addition, an average grain diameter may be calculated by image processing or the like based on a plurality of TEM structure observation images in which a plurality of crystals are present. In addition, the crystal grain diameter may also be estimated using a Sherer method based on a diffraction peak of a target crystal phase obtained using the X-ray diffraction method. Further, for a crystal structure having a large grain diameter, the crystal grain diameter may be measured using a method such as observing a cross section using an optical microscope or a scanning electron microscope (SEM).

The average particle diameter of the first magnetic particles 110 is preferably 1 μm or more and 30 μm or less. When the average particle diameter of the first magnetic particles 110 is 1 μm or more, the saturation magnetization of the first magnetic particles 110 can be effectively increased. As a result, in the magnetic separation, a moving speed of the magnetic bead 100 can be increased, and a time required for the magnetic separation can be shortened. In addition, when the average particle diameter of the first magnetic particles 110 is 30 μm or less, a specific surface area of the first magnetic particles 110 can be prevented from being excessively decreased. When the specific surface area of the first magnetic particles 110 is excessively small, for example, there is a possibility that the specific surface area of the entire magnetic bead 100 decreases due to a small specific surface area of the first magnetic particles 110 itself or a decrease in number of the second magnetic particles 120 that can suitably come into contact with the first magnetic particles 110. As a result, there is a possibility that an amount of the target biological substance adsorbed to the magnetic bead 100 in the magnetic separation decreases. When the average particle diameter of the first magnetic particles 110 is 30 μm or less, such a decrease in specific surface area of the magnetic bead 100 can be prevented, and a decrease in amount of the adsorbed target biological substance can be prevented.

Note that, the average particle diameter of the first magnetic particles 110 is more preferably 2 μm or more. That is, the average particle diameter of the first magnetic particles 110 is more preferably 2 μm or more and 30 μm or less, for example. In addition, the average particle diameter of the first magnetic particles 110 is more preferably 5 μm or less. That is, the average particle diameter of the first magnetic particles 110 is more preferably 1 μm or more and 5 μm or less, for example. In addition, the average particle diameter of the first magnetic particles 110 is still more preferably 2 μm or more and 5 μm or less.

The average particle diameter of the first magnetic particles 110 can be determined based on a cumulative distribution curve obtained from a volume-based particle size distribution measured by using a laser diffraction/scattering method. Specifically, in the cumulative distribution curve, a particle diameter D50 (median diameter) having a cumulative value of 50% from the small diameter side corresponds to the average particle diameter. Examples of a device that measures the particle size distribution by using the laser diffraction/scattering method include MT3300 series manufactured by MicrotracBEL Corp.

The second magnetic particles 120 are particles having magnetism. In the embodiment, the second magnetic particles 120 are configured with a crystalline metal oxide. More specifically, the second magnetic particles 120 are configured with magnetite (FeO·Fe₂O₃), which is a type of ferrite. Note that, in other embodiments, the composition and the structure of the second magnetic particles 120 are not limited to those described above, and may be, for example, the same as the composition and the structure of the first magnetic particles 110.

The average particle diameter of the second magnetic particles 120 is preferably 8 nm or more. Here, usually, the smaller the average particle diameter of the second magnetic particles 120 in contact with the first magnetic particles 110, the more the specific surface area of the magnetic bead 100 is increased. On the other hand, magnetization of the second magnetic particles 120 increases as the average particle diameter of the second magnetic particles 120 increases. As a result, a possibility that the first magnetic particles 110 and the second magnetic particles 120 are unintentionally separated from each other during the magnetic separation can be reduced. In addition, the contact between the first magnetic particles 110 and the second magnetic particles 120 using an external magnetic field in a contact step to be described later is promoted, and production efficiency of the magnetic bead 100 can be improved. Therefore, when the average particle diameter of the second magnetic particles 120 is 8 nm or more, both a large specific surface area of the magnetic bead 100 and high production efficiency can be achieved.

As described above, the coating layer 150 has a binding property to the target biological substance. More specifically, the coating layer 150 has a material or a chemical structure having a binding property to a biological material. Examples of such a material or chemical structure include the following.

A first preferred material of the coating layer 150 is an oxide film such as a silicon oxide. The silicon oxide is a material particularly suitable for extraction of a nucleic acid such as DNA and RNA, and in a composition formula, for example, SiOₓ (0 < x ≤ 2) is preferred, and specifically, SiO₂ is preferred. The silicon oxide enables extraction and recovery of the nucleic acid by specifically adsorbing the nucleic acid in an aqueous solution containing a chaotropic material. The "chaotropic material" is a material that has a function of improving water solubility of hydrophobic molecules and that contributes to nucleic acid adsorption. Specific examples of the chaotropic material include guanidine hydrochloride, sodium iodide, and sodium perchlorate. In addition, a composite oxide or a composite of Si and one oxide or two or more oxides selected from the group including Al, Ti, vanadium (V), Nb, Cr, Mn, Sn, and Zr may be contained. Al, Ti, V, Nb, Cr, Mn, Sn, and Zr are elements that prevent ion elution from the particle aggregate 105, that is, elements that are excellent in so-called elution resistance. Therefore, by using an oxide, a composite oxide, or a composite of these elements as the coating layer 150, it is possible to improve an extraction performance for the target biological substance while ensuring the elution resistance. In addition, a plurality of layers may be formed of oxides or the like having different elements in the coating layer 150.

A second preferred material of the coating layer 150 is a material having a functional group having a binding property to the target biological substance. Examples of the functional group having a binding property include an OH group, a COOH group, a NH₂ group, an epoxy group, a trimethylsilyl group, and an NHS group, depending on the type of the target biological substance.

Other examples of preferred materials of the coating layer 150 include proteins such as streptavidin, protein A, and protein G, and carbon. In addition, when the target biological substance is a nucleic acid, a nucleic acid having a property complementary to the nucleic acid as the target biological substance, specifically, oligo (dT) primer cDNA or the like is also a preferred material. Further, in the case of cell separation or exosome separation, examples thereof include antibodies such as CD3, CD4, CD8, CD9, CD63, and CD81.

It is desirable that the coating layer 150 does not capture a material different from the target biological substance. From this viewpoint, the coating layer 150 preferably contains a material called a blocking material together with the above preferred material of the coating layer 150. Examples of the blocking material include polyethylene glycol, albumin, and dextrin.

The coating layer 150 may contain impurities as long as the effects thereof are not impaired. For example, when the silicon oxide is used as the coating layer 150, impurities in the silicon oxide include C, N, P, or the like. The material and the composition of the coating layer 150 can be checked by, for example, EDX analysis or Auger electron spectroscopy.

The coating layer 150 preferably has a thickness of 10 nm or more and 30 nm or less. When the thickness of the coating layer 150 is 10 nm or more, a protection performance for the particle aggregate 105 by the coating layer 150 can be further enhanced. As a result, for example, damage to the coating layer 150 due to collision of the magnetic bead 100 in the magnetic separation can be prevented. The "collision of the magnetic bead 100" includes collision between the magnetic beads 100, collision between the magnetic bead 100 and a container, and the like. The "damage to the coating layer 150" includes breakage of the coating layer 150, peeling- off of the coating layer 150, and the like. Since the damage to the coating layer 150 is prevented as described above, it is possible to prevent a decrease in extraction efficiency for the target biological substance and generation of impurities due to the peeling off of the coating layer 150. In addition, since the damage to the coating layer 150 is prevented, it is possible to prevent the occurrence of ion elution due to the exposure of the particle aggregate 105. As a result, it is possible to prevent a decrease in magnetization per unit volume of the particle aggregate 105, and it is possible to prevent a decrease in moving speed of the particle aggregate 105 in the solid-liquid separation. In addition, when the thickness of the coating layer 150 is 30 nm or less, it is possible to prevent a decrease in specific surface area of the magnetic bead 100 due to an increase in thickness of the coating layer 150. In addition, the thickness is more preferably 20 nm or less. That is, the thickness is more preferably 10 nm or more and 20 nm or less, for example.

The thickness of the coating layer 150 can be measured using, for example, a cross-sectional observation image of the magnetic bead 100 by a transmission electron microscope. More specifically, the thickness in the embodiment is a value obtained by measuring the thickness of the coating layer 150 at five or more positions for each of ten particle aggregates 105 to obtain an average value of the thickness, and then further averaging the average values of the respective thicknesses. Note that, the number of the particle aggregates 105 is counted in units of the first magnetic particles 110.

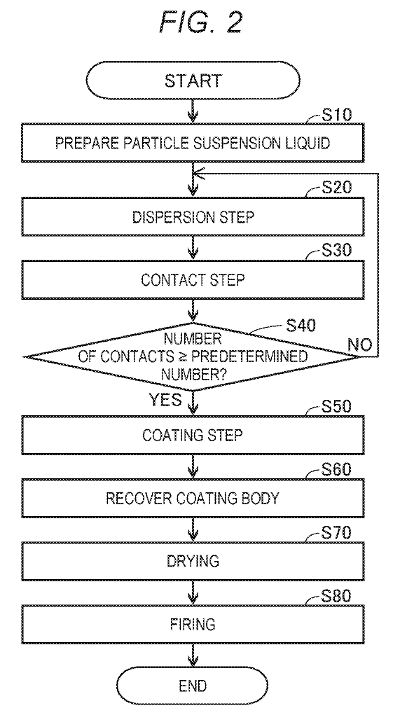

FIG. 2 is a step chart showing a method for producing the magnetic bead 100 according to the embodiment. In step 10, a particle suspension liquid in which the first magnetic particles 110 and the second magnetic particles 120 are suspended in a dispersion medium is prepared. In the embodiment, the dispersion medium for the particle suspension liquid is ethanol. In step S10, for example, the particle suspension liquid is prepared by mixing a dispersion medium prepared in advance, the first magnetic particles 110, and the second magnetic particles 120. Note that, in step S10, a particle suspension liquid prepared in advance may be prepared.

In step S20, a dispersion step is performed. The dispersion step is a step of dispersing the solid phase in the particle suspension liquid by stirring the particle suspension liquid. The dispersion step is performed in a state where no external magnetic field is applied to the particle suspension liquid. The solid phase herein may include the particle aggregate 105, the single first magnetic particles 110, and the single second magnetic particles 120. In step S20 in the embodiment, the particle suspension liquid is stirred for a predetermined stirring time by applying ultrasonic waves to the particle suspension liquid. In the embodiment, the stirring time is 90 minutes. In the dispersion step, the particle suspension liquid is preferably stirred such that the solid phase is uniformly dispersed in the particle suspension liquid.

In step S30, a contact step is performed. The contact step is a step of bringing the first magnetic particles 110 and the second magnetic particles 120 into contact with each other using an external magnetic field. The contact step is performed in a state where the particle suspension liquid is not stirred. In step S30 in the embodiment, an external magnetic field is applied to the particle suspension liquid by bringing a plurality of neodymium magnets close to a side surface or a bottom surface of a container containing the particle suspension liquid in a state where the application of ultrasonic waves to the particle suspension liquid is stopped. A surface magnetic flux density of the neodymium magnet used in step S30 is, for example, 0.3 T. As a result, the first magnetic particles 110 and the second magnetic particles 120 in the particle suspension liquid move in the particle suspension liquid so as to be attracted by the magnetic field of the neodymium magnet. Then, the first magnetic particles 110 and the second magnetic particles 120 come into contact with each other by attracting each other by the magnetization of the magnetic particles while moving in the particle suspension liquid, that is, while being collected by the magnetic field of the neodymium magnet. As a result, the particle aggregate 105 is formed. Hereinafter, the number of times the contact step is performed is also referred to as the number of contacts.

In step S40, it is determined whether the number of contacts is equal to or greater than a predetermined number. In the embodiment, the predetermined number of times is two or more. When the number of contacts is less than the predetermined number in step S40, step S20 and step S30 are performed again. That is, in the embodiment, the dispersion step in step S20 and the contact step in step S30 are repeatedly performed a plurality of times until the number of contacts reaches the predetermined number. Note that, as described above, the external magnetic field is not applied to the particle suspension liquid in step S20 again, and when the second magnetic particles 120 are suitably adsorbed to the first magnetic particles 110 in step S30, the state where the first magnetic particles 110 and the second magnetic particles 120 are in contact with each other is maintained also in step S20 again. By repeatedly performing the dispersion step and the contact step a plurality of times as described above, the first magnetic particles 110 and the second magnetic particles 120 can be more effectively brought into contact with each other, and more second magnetic particles 120 can adhere to the first magnetic particles 110. As a result, the specific surface area of the magnetic bead 100 can be further increased.

When the number of times of performing the contact step is equal to or greater than the predetermined number of times in step S40, a coating step is performed in step S50. The coating step is a step of forming the coating layer 150 to commonly cover the first magnetic particles 110 and the second magnetic particles 120 in contact with each other. In step S50 in the embodiment, the coating layer 150 is formed by particle coating using a sol-gel method. More specifically, in step S50, pure water, a catalyst, and tetraethyl orthosilicate (TEOS) are added to the suspension liquid, and hydrolysis and a polycondensation reaction of TEOS are caused to proceed, thereby forming a silica layer as the coating layer 150 so as to cover the first magnetic particles 110 and the second magnetic particles 120 in contact with each other. In the embodiment, as the catalyst in the coating step, a basic catalyst, more specifically, ammonia is used. The particle aggregate 105 in which the coating layer 150 is formed by the coating step is also referred to as a coating body.

In step S60, the coating body is recovered from the suspension liquid. In step S60 in the embodiment, the coating body is collected by applying an external magnetic field to the suspension liquid, and the coating body is recovered by replacing the dispersion medium around the collected coating body with new ethanol. In step S70, the coating body recovered in step S60 is dried. In step S70 in the embodiment, the coating body is dried by being heated at 100°C for 1 hour. In step S80, the coating body after drying is fired. In step S80 in the embodiment, the coating body is fired by being heated at 200°C for 2 hours. When step S80 is completed, the magnetic bead 100 according to the embodiment is obtained. Note that, for example, after step S80, a post-treatment may be appropriately performed on the magnetic bead 100.

With the magnetic bead 100 according to the embodiment described above, since the first magnetic particles 110 and the second magnetic particles 120 in contact with each other are covered with the common coating layer 150, it is possible to reduce a possibility that the magnetic particles are unintentionally separated from each other during the magnetic separation or the like. As a result, in the magnetic separation, the target biological substance can be more efficiently extracted using the magnetic bead 100. More specifically, the target biological substance can be more efficiently extracted by effectively using high magnetization of the first magnetic particles 110 and a large specific surface area of the second magnetic particles 120 in the magnetic bead 100.

In the embodiment, the first magnetic particles 110 contain Fe and have an amorphous structure. Therefore, the magnetization of the first magnetic particles 110 can be further enhanced. In particular, in the embodiment, since the first magnetic particles 110 contain Fe as a main component, the magnetization of the first magnetic particles 110 can be further enhanced. In addition, since the first magnetic particles 110 have an amorphous structure having a volume fraction of 40% or more, the magnetization of the first magnetic particles 110 can be further enhanced.

In the embodiment, the average particle diameter of the first magnetic particles 110 is 1 μm or more and 30 μm or less. Therefore, it is possible to prevent a decrease in specific surface area of the magnetic bead 100 due to a large average particle diameter of the first magnetic particles 110 while more effectively enhancing the magnetization of the first magnetic particles 110. In this way, when the average particle diameter of the first magnetic particles 110 is 1 μm or more and 30 μm or less, it is possible to provide the magnetic bead 100 capable of achieving both the shortening of the time required for the magnetic separation and the adsorption efficiency for the target biological substance.

In the embodiment, the average particle diameter of the second magnetic particles 120 is 8 nm or more. Therefore, the magnetization of the second magnetic particles 120 can be further enhanced, and the possibility that the magnetic particles are separated from each other can be further reduced. In addition, in the steps of producing the magnetic bead 100, the first magnetic particles 110 and the second magnetic particles 120 can be suitably brought into contact with each other using an external magnetic field, and the production efficiency of the magnetic bead 100 can be enhanced. In this way, when the average particle diameter of the second magnetic particles 120 is 8 nm or more, it is possible to provide the magnetic bead 100 capable of achieving both a large specific surface area of the magnetic bead 100 and high production efficiency.

In the embodiment, the thickness of the coating layer 150 is 10 nm or more and 30 nm or less. Therefore, the first magnetic particles 110 and the second magnetic particles 120 can be more effectively protected by the coating layer 150, a decrease in surface area of the magnetic bead 100 due to an increase in thickness of the coating layer 150 can be prevented, and the target biological substance can be more efficiently extracted using the magnetic bead 100.

According to the embodiment, the magnetic bead 100 can be produced by a simple method of forming the coating layer 150 so as to commonly cover the first magnetic particles 110 and the second magnetic particles 120 in contact with each other by applying an external magnetic field. Here, as another method of increasing the specific surface area of the magnetic bead 100, there is a method of making the surface of the magnetic bead 100 porous using a template method. However, in the template method, it is usually necessary to heat the magnetic bead at a relatively high temperature higher than the Curie point of the magnetic particles in order to suitably remove the template. By heating the magnetic bead at such a relatively high temperature, sintering of the magnetic particles proceeds, the magnetization of the magnetic particles decreases, and the magnetization of the magnetic bead may decrease. In particular, when magnetic particles having an amorphous structure are used, a decrease in magnetization due to the sintering is remarkable. Since the method for producing the magnetic beads 100 according to the embodiment does not require a heating step at a relatively high temperature as described above, it is possible to prevent a decrease in magnetization due to the progress of sintering of the magnetic particles. As a result, the magnetization of the magnetic bead 100 can be further improved.

In addition, in the embodiment, since the contact step and the dispersion step are repeatedly performed in the steps of producing the magnetic bead 100, more second magnetic particles 120 can adhere to the first magnetic particles 110, and the specific surface area of the magnetic bead 100 can be further increased. As a result, the adsorption efficiency of the magnetic bead 100 to the target biological substance can be further enhanced.

### B. Evaluation Test

### B-1: Outline of Evaluation Test

An evaluation test for evaluating the properties of the magnetic bead 100 according to the embodiment was performed.

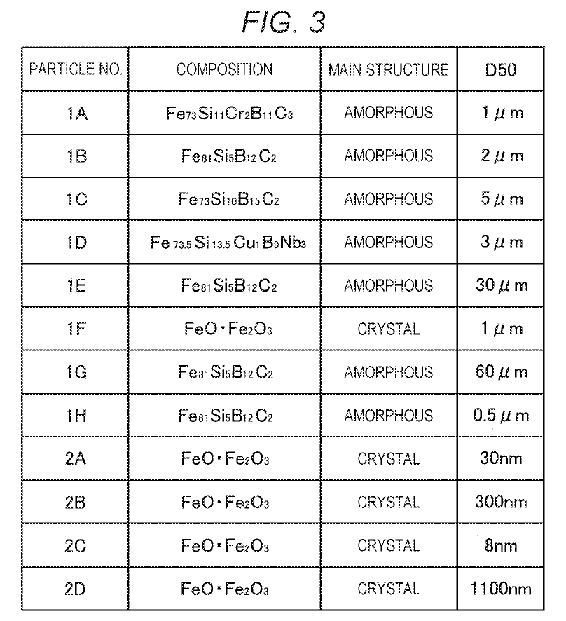

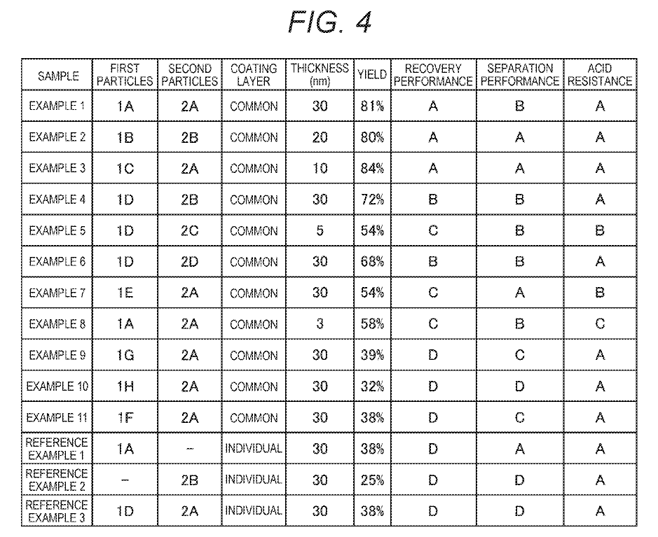

FIG. 3 is a diagram illustrating magnetic particles used in the evaluation test. FIG. 4 is a diagram illustrating evaluation results in the evaluation test. As shown in FIG. 4, in the evaluation test, magnetic beads in Examples 1 to 11 and magnetic beads in Reference Examples 1 and 2 were evaluated as samples. The magnetic beads in Examples 1 to 11 were prepared according to the production method in FIG. 2. In Examples 1 to 11, as shown in FIG. 4, the first particles were used as the first magnetic particles 110, and the second particles were used as the second magnetic particles 120. Note that, FIGS. 3 and 4 show "Particle No." of the magnetic particles used as the first particles and the second particles for each sample. A "common" coating layer in FIG. 4 represents a coating layer formed to commonly cover the first particles and the second particles. On the other hand, an "individual" coating layer in FIG. 4 represents a coating layer formed to individually cover each of the first particles and the second particles.

Unlike the magnetic beads in Examples 1 to 11, the magnetic beads in Reference Examples 1 and 2 were prepared using only the first particles or only the second particles, that is, using only a single type of magnetic particle. More specifically, in the magnetic bead production steps for Reference Examples 1 and 2, a suspension liquid in which only a single type of magnetic particle was suspended was prepared in step S10 in FIG. 2. The magnetic bead in Reference Example 3 was prepared using the first particles and the second particles in the same manner as the magnetic beads in Examples 1 to 11. On the other hand, in the magnetic bead in Reference Example 3, unlike the magnetic beads in Examples 1 to 11, a coating layer was individually formed for each of the first particles and the second particles. More specifically, the magnetic bead in Reference Example 3 was prepared by mixing two types of magnetic beads prepared in the same manner as the magnetic beads in Reference Examples 1 and 2.

As shown in FIG. 4, evaluation items for the magnetic beads in the evaluation test include recovery performance, separation performance, and acid resistance. The recovery performance is a performance related to a yield of the target biological substance. A magnetic bead having a higher recovery performance is highly likely to enable extraction and recovery of the target biological substance at a higher yield. The separation performance is a performance related to ease of the solid-liquid separation of the magnetic bead in the magnetic separation. A magnetic bead having a higher separation performance is highly likely to be separated from a liquid phase in a shorter time in the solid-liquid separation. The acid resistance is a performance related to durability of the magnetic bead under acidic conditions. A magnetic bead having higher acid resistance is less likely to elute ions from the magnetic particles in the magnetic bead, even under acidic conditions.

### B-2: Evaluation of Recovery Performance

The recovery performance of the magnetic bead was evaluated based on a nucleic acid yield in each sample in the magnetic separation. The recovery performance was evaluated according to the following evaluation criteria.

Evaluation Criteria for Recovery Performance

Evaluation A: the nucleic acid yield is 80% or more

Evaluation B: the nucleic acid yield is 60% or more and less than 80%

Evaluation C: the nucleic acid yield is 40% or more and less than 60%

Evaluation D: the nucleic acid yield is less than 40%

More specifically, the recovery performance was evaluated by the following procedures (1a) to (17a).

(1a) Each sample shown in FIG. 4, a nucleic acid as the target biological substance, and lysozyme as an impurity were prepared. Note that, as the nucleic acid, "Human genomic DNA" manufactured by Promega Corporation was used. As the lysozyme, lysozyme manufactured by FUJIFILM Corporation was used.

(2a) For each sample, the magnetic bead was dispersed in pure water and stirred to prepare a first suspension liquid in which the magnetic bead was suspended in pure water. The content of each magnetic bead in each first suspension liquid was 53.17 mass%.

(3a) Reagents were charged into a tube. The reagents here include a first sample liquid. More specifically, 65 μL of pure water, 20 μL of a nucleic acid dispersion liquid having a concentration of 0.1 μg/μL, 750 μL of a lysis and adsorption liquid, 15 μL of a lysozyme aqueous solution having a concentration of 10 μg/μL, and 40 μL of the first sample liquid were charged into the tube. Note that, among the reagents charged into the tube, the reagents other than the nucleic acid dispersion liquid were left until the temperature reached room temperature, and then charged into the tube. Note that, as the lysis and adsorption liquid, a lysis and adsorption liquid included in "MagExtractor -Genome-" (registered trademark) manufactured by TOYOBO CO., LTD. was used.

(4a) The contents in the tube were stirred for 10 minutes using a vortex mixer.

(5a) A magnetic collection step of magnetically collecting the magnetic bead was performed. More specifically, in the magnetic collection step, the tube was set on a predetermined magnetic stand and left for 30 seconds. The magnetic stand includes a magnet disposed to face an outer surface of the set tube. The magnetic bead is magnetically collected in the tube using an external magnetic field generated by the magnet disposed in the magnetic stand. The surface magnetic flux density of the magnet provided in the magnetic stand is 50 mT or more. The shortest distance between the tube set on the magnetic stand and the magnet is 10 mm or less. The magnetic collection step can also be referred to as a step of solid-liquid separating the magnetic bead in the tube.

(6a) A supernatant removal step of removing a supernatant of the magnetic bead collected in the magnetic collection step was performed.

(7a) A first cleaning step was performed. In the first cleaning step, the magnetic bead was cleaned by adding 900 μL of a cleaning liquid to the tube and stirring the contents in the tube for 5 seconds using a vortex mixer. As the cleaning liquid, a cleaning liquid included in "MagExtractor -Genome-" (registered trademark) manufactured by TOYOBO CO., LTD. was used. Note that, as the cleaning liquid, for example, an organic solvent such as isopropyl alcohol or acetone, an aqueous solution thereof, or a low salt concentration aqueous solution may be used. Examples of the low salt concentration aqueous solution include a buffer solution. A salt concentration in the low salt concentration aqueous solution is preferably 0.1 mM or more and 100 mM or less, and more preferably 1 mM or more and 50 mM or less. A salt for the buffer solution is not particularly limited, and a salt such as TRIS, HEPES, PIPES, and phosphoric acid is preferably used. The cleaning liquid may contain a surfactant such as Triton (registered trademark), Tween (registered trademark), or SDS. The cleaning liquid may contain a chaotropic material such as guanidine hydrochloride. The pH of the cleaning liquid is not particularly limited.

(8a) The magnetic collection step, the supernatant removal step, and the first cleaning step were performed again.

(9a) The magnetic collection step and the supernatant removal step were performed again.

(10a) A second cleaning step was performed. In the second cleaning step, 900 μL of a 70% ethanol aqueous solution was added to the tube, and the magnetic bead was cleaned by stirring the contents in the tube for 5 seconds using a vortex mixer.

(11a) The magnetic collection step and the supernatant removal step were performed again.

(12a) The second cleaning step, the magnetic collection step, and the supernatant removal step were performed again.

(13a) After adding 100 μL of pure water to the tube, the contents in the tube were stirred for 1 minute using a vortex mixer to elute the nucleic acid captured by the magnetic bead into the pure water.

(14a) By performing the magnetic collection step, a solid phase containing the magnetic bead and a liquid phase were separated from each other in the eluate.

(15a) The eluate separated from the magnetic bead was recovered into another tube.

(16a) The recovered eluate was set in an absorptiometer, and the concentration of the nucleic acid in the eluate was measured based on an absorbance at a wavelength of 260 nm. Note that, since the nucleic acid base has an absorption maximum around a wavelength of 260 nm, it is useful to use the absorbance at a wavelength of 260 nm for quantification of the concentration of the nucleic acid.

(17a) A nucleic acid recovery amount was calculated based on the measurement result of the concentration of the nucleic acid, and a ratio of the nucleic acid recovery amount to a nucleic acid charging amount was calculated as the nucleic acid yield.

### B-3: Evaluation of Separation Performance

The separation performance was evaluated based on a separation time of the magnetic bead. The separation time means a time required for solid-liquid separation of the magnetic bead in the magnetic separation. The separation performance was evaluated according to the following evaluation criteria.

Evaluation Criteria for Magnetic Separation Performance

Evaluation A: the magnetic separation time is shorter than 20 seconds

Evaluation B: the magnetic separation time is 20 seconds or longer and shorter than 60 seconds

Evaluation C: the magnetic separation time is 60 seconds or longer and shorter than 360 seconds

Evaluation D: the magnetic separation time is 360 seconds or longer

More specifically, the magnetic separation performance was evaluated by the following procedures (1b) to (4b).

(1b) A second suspension liquid in which the magnetic bead was suspended in pure water was prepared for each sample. More specifically, the second suspension liquid was prepared by suspending the magnetic bead in pure water at 25°C such that the content of the magnetic bead in the second suspension liquid was 0.1 mass%.

(2b) The second suspension liquid was stirred in a spectroscopic cell used in a spectrophotometer. More specifically, first, the second suspension liquid was charged into the spectroscopic cell. Thereafter, the second suspension liquid in the spectroscopic cell was stirred for 1 minute by applying ultrasonic waves and stirred for 1 minute using a vortex mixer.

(3b) For the stirred second suspension liquid, the absorbance at a wavelength of 550 nm was measured using a spectrophotometer, and a decay time until the absorbance at a wavelength of 550 nm decayed by 90% from the initial value was measured. More specifically, after the stirring in (2b) above was performed, the spectroscopic cell containing the second suspension liquid was quickly installed in a cell holder of the spectrophotometer. Then, the measurement of the absorbance and the decay time was started simultaneously with the start of the installation of the spectroscopic cell in the cell holder. Since the magnetic bead has a property of absorbing light having a wavelength of 550 nm, a degree of separation between the solid phase and the liquid phase containing the magnetic bead in the second suspension liquid can be suitably examined using the decay time of the absorbance at a wavelength of 550 nm. The decay time measured here corresponds to the separation time. Note that, a magnet having a surface magnetic flux density of 180 mT is attached in advance to a portion of the cell holder corresponding to the disposition position of the spectroscopic cell. The disposition position of the magnet is set such that the shortest distance between an outer wall of the spectroscopic cell installed in the cell holder and the magnet is 2.0 mm.

### B-4: Evaluation of Acid Resistance

The acid resistance was evaluated based on the concentration of iron ions eluted from the magnetic bead under acidic conditions. The acid resistance was evaluated according to the following evaluation criteria.

Evaluation Criteria for Acid Resistance

Evaluation A: the concentration of iron ions is 0.2 ppm or less

Evaluation B: the concentration of iron ions is more than 0.2 ppm and 0.5 ppm or less

Evaluation C: the concentration of iron ions is more than 0.5 ppm and 1.0 ppm or less

Evaluation D: the concentration of iron ions is more than 1.0 ppm

More specifically, the acid resistance was evaluated by the following procedures (1c) to (4c).

(1c) A third suspension liquid in which the magnetic bead was suspended in pure water was prepared for each sample. The third suspension liquid was prepared by charging 40 mg of pure water and 50 mg of the magnetic bead into a 1.5 mL tube and suspending the magnetic bead in pure water in the tube.

(2c) 160 μL of 5 mM hydrochloric acid was added to the tube, and the contents in the tube were stirred for 30 minutes using a vortex mixer.

(3c) 600 μL of the standard solution was added to the supernatant of the magnetic beads obtained in (2c) above to obtain a sample liquid. Note that, the standard solution was prepared by introducing 10 mL of a 60 mM hydroxylamine solution, 20 mL of a 1 M sodium acetate solution, 10 mL of a 1,10-phenanthroline solution having a concentration of 0.25 mass%, and pure water into a 110 mL screw tube in this order. At this time, pure water was added such that the total amount of the standard solution was 100 mL. (4c) The sample liquid was set in an absorptiometer, the absorbance at a wavelength of 510 nm was measured, and the concentration of iron ions was measured based on the absorbance at a wavelength of 510 nm. Since a complex formed of the iron ions and 1,10-phenanthroline has an absorption maximum wavelength around 510 nm, the concentration of iron ions can be suitably measured using the absorbance at a wavelength of 510 nm. The iron ions detected at this time correspond to the iron ions eluted from the magnetic particles of the magnetic bead into the suspension liquid.

### B-5: Evaluation Results

As shown in FIG. 4, in each of Examples 1 and 8 and Reference Example 1, the magnetic particles 1A are used as the first particles. The separation performance in Examples 1 and 8 and the separation performance in Reference Example 1 are both relatively high. In addition, the recovery performance in Examples 1 and 8 is higher than the recovery performance in Reference Example 1. It is considered that in Examples 1 and 8, unlike Reference Example 1, since two types of magnetic particles including the first particles and the second particles, that is, both the first magnetic particles 110 and the second magnetic particles 120 are contained, a large specific surface area of the second magnetic particles 120 enhances the adsorption efficiency of the target biological substance to the magnetic bead 100, and as a result, the recovery performance of the magnetic bead 100 is enhanced.

In each of Examples 2 and 4 and Reference Example 2, the magnetic particles 2B are used as the second particles. The separation performance in Examples 2 and 4 is higher than the separation performance in Reference Example 2. In addition, the recovery performance in Examples 2 and 4 is higher than the recovery performance in Reference Example 2. It is considered that in Examples 2 and 4, unlike Reference Example 2, since both the first magnetic particles 110 and the second magnetic particles 120 are contained, high magnetization of the first magnetic particles 110 enhances the magnetization of the magnetic bead 100, and as a result, the separation performance and the recovery performance of the magnetic bead 100 are improved.

In each of Examples 4, 5, and 6 and Reference Example 3, two types of magnetic particles are used, and the magnetic particles 1D are used as the first particles. The separation performance in Examples 4 to 6 is higher than the separation performance in Reference Example 3. In addition, the recovery performance in Examples 4 to 6 is higher than the recovery performance in Reference Example 3. As described above, in Examples 4 to 6, unlike Reference Example 3, the coating layer 150 is formed to commonly cover the first particles and the second particles, that is, to commonly cover the first magnetic particles 110 and the second magnetic particles 120. As a result, it is considered that the separation of the first magnetic particles 110 and the second magnetic particles 120 during the magnetic separation is prevented, and high magnetization of the first magnetic particles 110 and a large specific surface area of the second magnetic particles 120 are effectively used to extract the target biological substance.

The separation performance in Examples 1 to 9 is higher than the separation performance in Example 10. As shown in FIGS. 3 and 4, the average particle diameter of the magnetic particles 1H in Example 10, that is, the first magnetic particles 110, is 0.5 μm. On the other hand, the average particle diameter of the first magnetic particles 110 in Examples 1 to 9 is 1 μm or more. It is considered that, in Examples 1 to 9, since the average particle diameter of the first magnetic particles 110 is 1 μm or more, the magnetization of the magnetic bead 100 is effectively enhanced by high magnetization of the first magnetic particles 110, and the separation performance of the magnetic bead 100 is further enhanced. In particular, in Examples 2, 3, and 7 in which the average particle diameter of the first magnetic particles 110 is 2 μm or more, the separation performance of the magnetic bead 100 is more remarkably high.

As shown in FIG. 4, the recovery performance in Examples 1 to 8 is higher than the recovery performance in Example 9. As shown in FIGS. 3 and 4, the average particle diameter of the magnetic particles 1G in Example 9, that is, the first magnetic particles 110, is 60 μm. On the other hand, the average particle diameter of the first magnetic particles 110 in Examples 1 to 8 is 30 μm or less. It is considered that, in Examples 1 to 8, when the average particle diameter of the first magnetic particles 110 is 30 μm or less, a decrease in specific surface area of the entire magnetic bead 100 due to the first magnetic particles 110 is prevented, and the recovery performance of the magnetic bead 100 is further enhanced. In particular, in Examples 2 and 3 in which the average particle diameter of the first magnetic particles 110 is 5 μm or less, the separation performance of the magnetic bead 100 is more remarkably high.

As shown in FIG. 4, the acid resistance in Examples 1 to 4, 6, 7, and 9 to 11 is equal to or higher than the acid resistance in Example 5, and is higher than the acid resistance in Example 8. It is considered that, in Examples 1 to 4, 6, 7, and 9 to 11, since the thickness was 10 nm or more, the protection performance of the particle aggregate 105 by the coating layer 150 is improved, and the acid resistance of the magnetic bead 100 is improved.

As shown in FIG. 4, the recovery performance, the separation performance, and the acid resistance in Examples 2 and 3 are all remarkably higher than those in the other Examples and Reference Examples. Therefore, as shown in FIGS. 3 and 4, the average particle diameter of the first magnetic particles 110 is more preferably 2 μm or more and 5 μm or less. In addition, the average particle diameter of the second magnetic particles 120 is more preferably 30 μm or more and 300 nm or less. In addition, the thickness is more preferably 10 nm or more and 20 nm or less. In addition, the main structure of the first magnetic particles 110 is preferably an amorphous structure. In addition, the main structure of the second magnetic particles 120 is preferably a crystal structure.

As shown in FIGS. 3 and 4, in Example 1 and Example 11, the average particle diameters of the first particles are the same, and the same magnetic particles 2A are used as the second particles. As shown in FIG. 4, the separation performance in Example 1 is higher than the separation performance in Example 11. In addition, the recovery performance in Example 1 is higher than the recovery performance in Example 11. It is considered that, in Example 1, unlike Example 11, the main structure of the first particles, that is, the first magnetic particles 110 is an amorphous structure, and thus the magnetization of the first magnetic particles 110 is enhanced, and the separation performance and the recovery performance of the magnetic bead 100 are enhanced.

According to the evaluation results described above, it is found that the possibility that the magnetic particles are unintentionally separated from each other can be reduced by the magnetic bead 100 according to the embodiment, and the target biological substance can be more efficiently extracted.

### C. Other Aspects

The present disclosure is not limited to the embodiment described above, and can be implemented in various forms without departing from the scope of the present disclosure. For example, the present disclosure may also be implemented in the following aspects. The technical features in the embodiments described above corresponding to the technical features in the aspects described below can be replaced or combined as appropriate in order to solve a part or all of the problems of the present disclosure, or to achieve a part or all of the advantages of the present disclosure. Further, any of the technical features can be eliminated as appropriate unless described as essential in the present specification.

(1) According to a first aspect of the present disclosure, a magnetic bead is provided. The magnetic bead contains: first magnetic particles having magnetism; second magnetic particles having magnetism, the second magnetic particles being in contact with the first magnetic particles and having an average particle diameter smaller than an average particle diameter of the first magnetic particles; and a coating layer commonly covering the first magnetic particles and the second magnetic particles, the coating layer having a binding property to a target biological substance.

According to this aspect, since the first magnetic particles and the second magnetic particle in contact with each other are covered with the common coating layer, it is possible to reduce a possibility that the magnetic particles are separated from each other during magnetic separation or the like. As a result, in the magnetic separation, the target biological substance can be more efficiently extracted using the magnetic bead.

(2) In the above aspect, the first magnetic particles may contain iron and have an amorphous structure. According to this aspect, the magnetization of the first magnetic particles can be further enhanced.

(3) In the above aspect, the average particle diameter of the first magnetic particles may be 1 μm or more and 30 μm or less. According to this aspect, the magnetization of the first magnetic particles can be more effectively enhanced.

(4) In the above aspect, the average particle diameter of the second magnetic particle may be 8 nm or more. According to this aspect, the magnetization of the second magnetic particle can be further enhanced, and the possibility that the magnetic particles are separated from each other can be further reduced.

(5) In the above aspect, a thickness of the coating layer may be 10 nm or more and 30 nm or less. According to this aspect, the first magnetic particles and the second magnetic particle can be more effectively protected by the coating layer. In addition, a decrease in surface area of the magnetic bead due to an increase in thickness of the coating layer can be prevented, and the target biological substance can be more efficiently extracted using the magnetic bead.

(6) According to a second aspect of the present disclosure, a method for producing a magnetic bead is provided. The production method includes: a contact step of applying a magnetic field to first magnetic particles having magnetism and second magnetic particles having magnetism and having an average particle diameter smaller than an average particle diameter of the first magnetic particles to bring the first magnetic particles and the second magnetic particles into contact with each other; and a coating step of forming a coating layer having a binding property to a target biological substance so as to commonly cover the first magnetic particles and the second magnetic particles in contact with each other.

The present disclosure is not limited to the magnetic bead and the method for producing a magnetic bead described above, and can be implemented by various aspects such as a method for extracting a biological material.

What is claimed is:

1. A magnetic bead comprising:
a first magnetic particle having magnetism;
second magnetic particles having magnetism, the second magnetic particles being in contact with the first magnetic particle and having an average particle diameter smaller than an average particle diameter of the first magnetic particle; and
a coating layer commonly covering the first magnetic particle and the second magnetic particles, the coating layer having a binding property to a target biological substance.

2. The magnetic bead according to claim 1, wherein
the first magnetic particle contain iron and have an amorphous structure.

3. The magnetic bead according to claim 1, wherein
the average particle diameter of the first magnetic particles is 1 μm or more and 30 μm or less.

4. The magnetic bead according to claim 1, wherein
the average particle diameter of the second magnetic particles is 8 nm or more.

5. The magnetic bead according to claim 1, wherein
the coating layer has a thickness of 10 nm or more and 30 nm or less.

6. A method for producing a magnetic bead, comprising:
a contact step of applying a magnetic field to first magnetic particle having magnetism and second magnetic particles having magnetism and having an average particle diameter smaller than an average particle diameter of the first magnetic particle to bring the first magnetic particle and the second magnetic particles into contact with each other; and
a coating step of forming a coating layer having a binding property to a target biological substance so as to commonly cover the first magnetic particle and the second magnetic particles in contact with each other.
